(19) United States
(12) Patent Application Publication
(10) Pub. No.: US 2025/0043465 A1
(43) Pub. Date: Feb. 6, 2025

(54) MELT-SPUN THERMOPLASTIC POLYURETHANE FIBER

(71) Applicant: Lubrizol Advanced Materials, Inc., Cleveland, OH (US)

(72) Inventors: LALITH BHARGAVA SURAGANI VENU, North Royalton, OH (US); MICHAEL B. RAMSAY, Newbury, OH (US); JOSEPH J. VONTORCIK, JR., Broadview Hts., OH (US); CHRISTOPHER A. SPRAGUE, Cuyahoga Falls, OH (US); QIANG LAN, Solon, OH (US); ANGELINA CHAN, Cleveland, OH (US)

(21) Appl. No.: 18/718,178

(22) PCT Filed: Dec. 9, 2022
(86) PCT No.: PCT/US2022/052336

§ 371 Date: Jun. 10, 2024

Related U.S. Application Data
(60) Provisional application No. 63/288,211, filed on Dec. 10, 2021.

(51) Int. Cl. D01F 6/70; C08G 18/10; C08G 18/42; C08G 18/48; C08G 18/76; D01D 1/04; D01D 5/088; D01F 11/08

(52) U.S. Cl. CPC D01F 6/70; C08G 18/10; C08G 18/4277; C08G 18/4854; C08G 18/7671; D01D 1/04; D01D 5/088; D01F 11/08; D10B 2331/10; D10B 2401/063

(57) ABSTRACT

A melt-spun thermoplastic polyurethane fiber is provided. The melt-spun thermoplastic polyurethane fiber provides elastic properties and exhibits chemical resistance.

### BACKGROUND OF THE INVENTION

Thermoplastic polyurethane (“TPU”) fibers show great potential for providing the stretch and fit properties in a variety of applications but have some drawbacks. Many polyurethane fibers are made by dry spinning processes that involve dissolving the reactive ingredients in solvent. Such fibers generally have good heat resistance, but the dry spinning process is expensive, time consuming, and involves the use of volatile solvents creating environmental concerns. Melt-spinning of fibers has manufacturing advantages, but not all TPU is amenable to forming a fiber under melt-spinning conditions. In addition, prior art TPUs that can be melt-spun into fibers do not exhibit chemical resistance sufficient for certain applications, such when used in electronics, auto-motive and apparel applications. Thus, it would be desirable to have a melt-spun TPU fiber that has superior elastomeric properties, but that also exhibits chemical resistance.

### SUMMARY OF THE INVENTION

In one embodiment, the present invention is a melt-spun fiber, wherein fiber comprises a reactive thermoplastic polyurethane composition and an isocyanate functional prepolymer cross-linking agent. The reactive thermoplastic polyurethane composition used in the fiber comprises the reaction product of (i) a polyol component which comprises or consists of a first polycarbonate polyol, (ii) a hydroxyl terminated chain extender component, and (iii) a first diisocyanate component. The isocyanate functional prepolymer crosslinking agent comprises the reaction product of a second polycarbonate polyol or a polycaprolactone polyol and a second diisocyanate component.

In another embodiment, the invention comprises a process for preparing a thermoplastic polyurethane having the following steps: (a) preparing a reactive thermoplastic polyurethane composition that is the reaction product of (a) a polyol component, wherein the polyol component comprises or consists of a first polycarbonate polyol, (b) a chain extender component; and (c) a diisocyanate; (2) drying the reactive thermoplastic polyurethane composition; (3) melting the reactive thermoplastic polyurethane composition in an extruder; (4) adding an isocyanate functional prepolymer into the extruder, wherein the isocyanate functional prepolymer comprises or consists of the reaction product of a second polycarbonate polyol or a polycaprolactone polyol and a second diisocyanate component; (5) mixing the reactive thermoplastic polyurethane composition and the isocyanate functional prepolymer in the extruder to form a crosslinked thermoplastic polyurethane polymer; (6) feeding the crosslinked thermoplastic polyurethane polymer to at least one spinneret to produce a melt-spun fiber; (7) cooling the melt-spun fiber; (8) optionally, applying a finish oil; and (9) winding the melt-spun fiber onto a bobbin.

In still another embodiment, the invention provides a fiber comprising a melt-spun thermoplastic polyurethane filament which retains at least 80% tenacity as measured according to ASTM D2653 after exposure to chemicals, such as oleic acid measured according to ASTM D543-20. In another embodiment, the invention provides a fabric which comprises a melt-spun thermoplastic polyurethane filament capable of retaining at least 80% of its original tensile properties measured according to ASTM D2653 after exposure to oleic acid and wherein the fiber has a fiber moduli measured according to ASTM D2731, of less than 0.9 gram-force at 50% elongation during fifth loading cycle, less than 2.1 gram-force at 100% elongation during fifth loading cycle, less than 4.3 gram-force at 200% elongation during fifth loading cycle, less than 2.8 gram-force at 200% elongation during fifth unloading cycle, less than 1.2 gram-force at 100% elongation during fifth unloading cycle, and less than 0.4 gram-force at 50% elongation during fifth unloading cycle a 300% ultimate elongation measured according to ASTM D2731.

The following embodiments of the present subject matter are contemplated:
1. A melt-spun fiber, comprising: (a) a reactive thermoplastic polyurethane composition, comprising the reaction product of: (i) a polyol component, wherein the polyol component comprises a first polycarbonate polyol; (ii) a hydroxyl terminated chain extender component; and (iii) a first diisocyanate component; and (b) an isocyanate functional prepolymer crosslinking agent comprising the reaction product of a second polycarbonate polyol and a second diisocyanate component, or (c) an isocyanate functional prepolymer crosslinking agent comprising the reaction product of a polycaprolactone polyol and a second diisocyanate component
2. The melt-spun fiber of embodiment 1, wherein the polyol component comprises at least 60% of the first polycarbonate polyol.
3. The melt-spun fiber of embodiment 1 or 2, wherein the first polycarbonate polyol contains a repeating unit —R—O—C(═O)—O— in which R contains 4 to 6 carbon atoms.
4. The melt-spun fiber of any preceding embodiment, wherein the first polycarbonate polyol has a number average molecular weight of about 1000 to 3000 Daltons measured by end group analysis.
5. The melt-spun fiber of any preceding embodiment, wherein the first polycarbonate polyol is selected from 2-MPD carbonate, BDO-carbonate, DEG-carbonate, HDO-carbonate, or mixtures thereof.
6. The melt-spun fiber of any preceding embodiment, wherein the polyol component consists of the first polycarbonate polyol.
7. The melt-spun fiber of any preceding embodiment, wherein the chain extender component comprises or consists of 1,4-bis(3-hydroxyethoxy)benzene or 1,3 propanediol.
8. The melt-spun fiber of any preceding embodiment, wherein the first diisocyanate component comprises or consists of an aromatic diisocyanate.
9. The melt-spun fiber of embodiment 8, wherein the first diisocyanate comprises or consists of 4,4′-diphenylmethane diisocyanate.
10. The melt-spun fiber of any of embodiments 1 to 7, wherein the first diisocyanate component comprises or consists of an aliphatic diisocyanate.
11. The melt-spun fiber of embodiment 10, wherein the first diisocyanate component comprises or consists of HDI.
12. The melt-spun fiber of any preceding embodiment, wherein the second diisocyanate component comprises or consists of an aromatic diisocyanate.
13. The melt-spun fiber of embodiment 12, wherein the second diisocyanate comprises or consists of 4,4′-diphenylmethane diisocyanate.
14. The melt-spun fiber of any of embodiments 1 to 11, wherein the second diisocyanate component comprises or consists of an aliphatic diisocyanate.
15. The melt-spun fiber of embodiment 14, wherein the second diisocyanate component comprises or consist of HDI.
16. The melt-spun fiber of any preceding embodiment, wherein the second polycarbonate polyol is selected from HDO-carbonate, BDO-carbonate, 3-MPD-carbonate, or mixtures thereof.
17. The melt-spun fiber of embodiments 1 to 15, wherein the polycaprolactone polyol comprises F-caprolactone may be reacted with bifunctional initiator.
18. The melt-spun fiber of embodiment 17, wherein the bifunctional initiator is selected form diethylene glycol, 1,4-butanediol, neopentyl glycol, poly(tetramethylene ether glycol) or mixtures thereof.
19. The melt-spun fiber of any preceding embodiment, wherein the reactive thermoplastic polyurethane composition contains 70% to 85% by weight or 75% to 85% by weight or 80% to 85% by weight of the first polycarbonate polyol component.
20. The melt-spun fiber of any preceding embodiment, wherein a combined weight of the hydroxyl terminated chain extender component and the first diisocyanate component make up a hard segment of the thermoplastic polyurethane composition and wherein the thermoplastic polyurethane composition has a hard segment content of 15% to 45% by weight or 20% to 35% by weight.
21. The melt-spun fiber of any preceding embodiment, wherein the isocyanate functional prepolymer crosslinking agent comprises the reaction product of 65% to 80% by weight or 70% to 80% by weight of the second polycarbonate polyol and 20% to 35% by weight or 20% to 30% by weight of the second diisocyanate component.
22. The melt-spun fiber of any preceding embodiment, comprising 85% to 90% of the TPU and 10% to 15% of the pre-polymer.
23. The melt-spun fiber of any preceding embodiment, wherein the melt-spun thermoplastic polyurethane fiber has a weight average molecular weight measured by gas permeation chromatography of 100,000 Daltons to 300,000 Daltons.
24. The melt-spun fiber of any preceding embodiment, wherein the thermoplastic polyurethane fiber is capable of retaining at least 80% of its original tensile properties measured according to ASTM D2653 after exposure to oleic acid measured per ASTM D543-20.
25. A fabric comprising the melt-spun fiber of any of the preceding embodiments.
26. A process for preparing a thermoplastic polyurethane fiber comprising the steps of: (1) preparing a reactive thermoplastic polyurethane composition that is the reaction product of (a) a polyol component, wherein the polyol component comprises a first polycarbonate polyol (b) a chain extender component; and (c) a first diisocyanate;
(2) drying the reactive thermoplastic polyurethane composition; (3) melting the reactive thermoplastic polyurethane composition in an extruder; (4) adding an isocyanate functional prepolymer into the extruder, wherein the isocyanate functional pre-polymer comprises the reaction product of a second polycarbonate polyol or a polycaprolactone polyol and a second diisocyanate component; (5) mixing the reactive thermoplastic polyurethane composition and the isocyanate functional prepolymer in the extruder to form a crosslinked thermoplastic polyurethane polymer; (6) feeding the crosslinked thermoplastic polyurethane polymer to at least one spinneret to produce a melt-spun fiber; (7) cooling the melt-spun fiber; (8) optionally, applying finish oil; and (9) winding the melt-spun fiber onto a bobbin.
27. The process of embodiment 26, wherein the polyol component comprises at least 60% of the first polycarbonate polyol.
28. The process of embodiment 26 or 27, wherein the first polycarbonate polyol contains a repeating unit —R—O—C(═O)—O— in which R contains 4 to 6 carbon atoms.
29. The process of any of embodiments 26 to 28, wherein the first polycarbonate polyol has a number average molecular weight of about 1000 to 3000 Daltons measured by end group analysis.
30. The process of any of embodiments 26 to 29, wherein the first polycarbonate polyol is selected from 2-MPD carbonate, BDO-carbonate, DEG-carbonate, HDO-carbonate, or mixtures thereof.
31. The process of any of embodiments 26 to 30, wherein the polyol component consists of the first polycarbonate polyol.
32. The process of any of embodiments 26 to 31, wherein the chain extender component comprises or consists of 1,4-bis(3-hydroxyethoxy)benzene or 1,3 propanediol.
33. The process of any of embodiments 26 to 32, wherein the first diisocyanate component comprises or consists of an aromatic diisocyanate.
34. The process of embodiment 33, wherein the first diisocyanate comprises or consists of 4,4′-diphenylmethane diisocyanate.
35. The process of any of embodiments 26 to 32, wherein the first diisocyanate component comprises or consists of an aliphatic diisocyanate.
36. The process of embodiment 35, wherein the first diisocyanate component comprises or consists of HDI.
37. The process of any of embodiments 26 to 36, wherein the second diisocyanate component comprises or consists of an aromatic diisocyanate.
38. The process of embodiment 37, wherein the second diisocyanate comprises or consists of 4,4′-diphenylmethane diisocyanate.
39. The process of any of embodiments 26 to 36, wherein the second diisocyanate component comprises or consists of an aliphatic diisocyanate.
40. The process of embodiment 39, wherein the second diisocyanate component comprises or consist of HDI.
41. The process of any of embodiments 26 to 40, wherein the second polycarbonate polyol is selected from HDO-carbonate, BDO-carbonate, 3-MPD-carbonate, or mixtures thereof.
42. The process of any of embodiments 26 to 40, wherein the polycaprolactone polyol comprises F-caprolactone may be reacted with bifunctional initiator.
43. The process of embodiment 42, wherein the bifunctional initiator is selected form diethylene glycol, 1,4-butanediol, neopentyl glycol, poly(tetramethylene ether glycol) or mixtures thereof
44. The process of any of embodiments 26 to 43, wherein the reactive thermoplastic polyurethane composition contains 70% to 85% by weight or 75% to 85% by weight or 80% to 85% by weight of the first polycarbonate polyol component.
45. The process of any of embodiments 26 to 44, wherein a combined weight of the hydroxyl terminated chain extender component and the first diisocyanate component make up a hard segment of the thermoplastic polyurethane composition and wherein the thermoplastic polyurethane composition has a hard segment content of 15% to 30% by weight or 20% to 25% by weight.
46. The process of any of embodiments 26 to 45, wherein the isocyanate functional prepolymer crosslinking agent comprises the reaction product of 65% to 80% by weight or 70% to 80% by weight of the second polycarbonate polyol and 20% to 35% by weight or 20% to 30% by weight of the second diisocyanate component.
47. The process of any of embodiments 26 to 46, wherein the melt-spun fiber comprises 85% to 90% of the TPU and 10% to 15% of the pre-polymer.
48. The process of any of embodiments 26 to 47, wherein the melt-spun thermoplastic polyurethane fiber has a weight average molecular weight measured by gas permeation chromatography of 100,000 Daltons to 300,000 Daltons.

These various embodiments are described in more detail below.

### DETAILED DESCRIPTION OF THE INVENTION

The features and embodiments of the present invention will be described below by way of the following non-limiting illustration.

The disclosed technology includes a melt-spun fiber comprising a reactive thermoplastic polyurethane (“TPU”) composition and an isocyanate functional cross-linking agent. The reactive TPU composition useful in making the melt-spun fiber of the present invention is the reaction product of a polyol component, a hydroxyl terminated chain extender component, and a diisocyanate component. The isocyanate functional cross-linking agent is the reaction product of a polyol with an excess of isocyanate. Each of these components will be described in more detail below.

As used herein, weight average molecular weight (Mw) is measured by gel permeation chromatography using polystyrene standards and number average molecular weight (Mn) is measured by end group analysis.

### Thermoplastic Polyurethane Composition

The reactive TPU compositions useful in making the melt-spun fiber of the present invention include a polyol component, which may also be described as a hydroxyl terminated intermediate. In the present invention, the polyol component comprises or consists of a polycarbonate polyol.

Suitable hydroxyl terminated polycarbonates include those prepared by reacting a glycol with a carbonate. U.S. Pat. No. 4,131,731 is hereby incorporated by reference for its disclosure of hydroxyl terminated polycarbonates and their preparation. Such polycarbonates are linear and have terminal hydroxyl groups with essential exclu-sion of other terminal groups. The essential reactants are glycols and carbonates. Suitable glycols are selected from cycloaliphatic and aliphatic diols containing 4 to 40, and or even 4 to 12 carbon atoms, and from polyoxyalkylene glycols containing 2 to 20 alkoxy groups per molecule with each alkoxy group containing 2 to 4 carbon atoms. Suitable diols include aliphatic diols containing 4 to 12 carbon atoms such as 1,4-butanediol, 1,5-pentanediol, neopentyl glycol, 1,6-hexanediol, 2,2,4-trimethyl-1,6-hexanediol, 1,10-decanediol, hydrogenated dilinoleylglycol, hydrogenated dioleylglycol, 3-methyl-1,5-pentanediol; and cycloaliphatic diols such as 1,3-cyclohexanediol, 1,4-dimethylolcyclohexane, 1,4-cyclohexanediol-, 1,3-dimethylolcyclohexane-, 1,4-endometh-ylene-2-hydroxy-5-hydroxymethyl cyclohexane, and polyalkylene glycols. The diols used in the reaction may be a single diol or a mixture of diols depending on the properties desired in the finished product. Polycarbonate intermediates which are hydroxyl terminated are generally those known to the art and in the literature. Suitable carbonates are selected from alkylene carbonates com-posed of a 5 to 7 member ring. Suitable carbonates for use herein include ethylene carbonate, trimethylene carbonate, tetramethylene carbonate, 1,2-propylene carbonate, 1,2-butylene carbonate, 2,3-butylene carbonate, 1,2-ethylene carbonate, 1,3-pentylene carbonate, 1,4-pentylene carbonate, 2,3-pentylene carbonate, and 2,4-pentylene carbonate. Also, suitable herein are dialkylcarbonates, cycloali-phatic carbonates, and diarylcarbonates. The dialkylcarbonates can contain 2 to 5 carbon atoms in each alkyl group and specific examples thereof are dieth-ylcarbonate and dipropylcarbonate. Cycloaliphatic carbonates, especially dicycloali-phatic carbonates, can contain 4 to 7 carbon atoms in each cyclic structure, and there can be one or two of such structures. When one group is cycloaliphatic, the other can be either alkyl or aryl. On the other hand, if one group is aryl, the other can be alkyl or cycloaliphatic. Examples of suitable diarylcarbonates, which can contain 6 to 20 carbon atoms in each aryl group, are diphenylcarbonate, ditol-ylcarbonate, and dinaphthylcar-bonate.

In one embodiment, the polyol component in the TPU composition comprises or consists of a polycarbonate polyol containing a repeating unit of —R—O—C(═O)—O—, wherein R contains 4 to 6 carbon atoms. In some embodiments, the polycarbonate polyol component may be selected from 2-methyl pentanediol (MPD) carbonate, butanediol (BDO) carbonate, diethylene glycol (DEG) carbonate, hexane diol (HDO) carbonate, or mixtures thereof. In one embodiment, the polyol component comprises a mixture of polycarbonate polyols.

In some embodiments, the polyol component of the TPU composition may contain one or more co-polyols such as polyesters, polyethers, polysiloxane polyols, or combinations thereof. However, in one embodiment, the polyol component contains at least 60% by weight polycarbonate polyol. In some embodiments, the polyol component contains at least 70%, at least 80%, at least 90%, or even 100% polycarbonate polyol.

In one embodiment, the polyol component may include a polyester polyol. Polyester polyols useful in the present invention may be produced by (1) an esterification reaction of one or more glycols with one or more dicarboxylic acids or anhydrides or (2) by transesterification reaction, i.e., the reaction of one or more glycols with esters of dicarboxylic acids. Mole ratios generally in excess of more than one mole of glycol to acid are preferred so as to obtain linear chains having a preponderance of terminal hydroxyl groups. Suitable polyester intermediates also include various lactones such as polycaprolactone typically made from F-caprolactone and a bifunctional initiator such as diethylene glycol. The dicarboxylic acids of the desired polyester can be aliphatic, cycloaliphatic, aromatic, or combinations thereof. In some embodiments, dicarboxylic acids which may be used alone or in mixtures generally have a total of from 4 to 15 carbon atoms and include: succinic, glutaric, adipic, pimelic, suberic, azelaic, sebacic, dodec-anedioic, isophthalic, terephthalic, cyclohexane dicarboxylic, and the like. Anhydrides of the above dicarboxylic acids such as phthalic anhydride, tetrahydrophthalic anhydride, or the like, can also be used. The glycols which are reacted to form a desirable polyester intermediate can be aliphatic, aromatic, or combinations thereof, including any of the glycols described above in the chain extender section, and have a total of from 2 to 20 or from 2 to 12 carbon atoms. Suitable examples include ethylene glycol, 1,2-propanediol, 1,3-propanediol, 1,3-butanediol, 1,4-butanediol, 1,5-pentanediol, 1,6-hexanediol, 2,2-dimethyl-1,3-propanediol, 1,4-cyclohexanedimethanol, decamethylene glycol, dodecamethylene glycol, and mixtures thereof.

The polyester polyol component may also include one or more polycaprolactone polyester polyols. The polycaprolactone polyester polyols useful in the technology described herein include polyester diols derived from caprolactone monomers. The polycaprolactone polyester polyols are terminated by primary hydroxyl groups. Suitable polycaprolactone polyester polyols may be made from F-caprolactone and a bifunctional initiator such as diethylene glycol, 1,4-butanediol, or any of the other glycols and/or diols listed herein. In some embodiments, the polycaprolactone polyester polyols are linear polyester diols derived from caprolactone monomers.

Useful examples include CAPA™ 2202A, a 2,000 number average molecular weight (Mn) linear polyester diol, and CAPA™ 2302A, a 3,000 Mn linear polyester diol, both of which are commercially available from Perstorp Polyols Inc. These materials may also be described as polymers of 2-oxepanone and 1,4-butanediol.

The polycaprolactone polyester polyols may be prepared from 2-oxepanone and a diol, where the diol may be 1,4-butanediol, diethylene glycol, monoethylene glycol, 1,6-hexanediol, 2,2-dimethyl-1,3-propanediol, or any combination thereof. In some embodiments, the diol used to prepare the polycaprolactone polyester polyol is linear. In some embodiments, the polycaprolactone polyester polyol is prepared from 1,4-butanediol. In some embodiments, the polycaprolactone polyester polyol has a number average molecular weight from 500 to 10,000, or from 500 to 5,000, or from 1,000 or even 2,000 to 4,000 or even 3,000.

In one embodiment, the polyol component may include a polyether polyol. Suitable polyether polyol intermediates include polyether polyols derived from a diol or polyol having a total of from 2 to 15 carbon atoms, in some embodiments an alkyl diol or glycol which is reacted with an ether comprising an alkylene oxide having from 2 to 6 carbon atoms, typically ethylene oxide or propylene oxide or mixtures thereof. For example, hydroxyl functional polyether can be produced by first reacting propylene glycol with propylene oxide followed by subsequent reaction with ethylene oxide. Primary hydroxyl groups resulting from ethylene oxide are more reactive than secondary hydroxyl groups and thus are preferred. Useful commercial polyether polyols include poly(ethylene glycol) comprising ethylene oxide reacted with ethylene glycol, poly(propylene glycol) comprising propylene oxide reacted with propylene glycol, poly(tetramethylene ether glycol) comprising water reacted with tetrahydrofuran which can also be described as polymerized tetrahydrofuran, and which is commonly referred to as PTMEG. In some embodiments, the polyether intermediate includes PTMEG. Suitable polyether polyols also include polyamide adducts of an alkylene oxide and can include, for example, ethylenediamine adduct comprising the reaction product of ethylenediamine and propylene oxide, diethylenetriamine adduct comprising the reaction product of diethylenetriamine with propylene oxide, and similar polyamide type polyether polyols. Copolyethers can also be utilized in the described compositions. Typical copolyethers include the reaction product of THF and ethylene oxide or THF and propylene oxide. These are available from BASF as PolyTHF® B, a block copolymer, and PolyTHF® R, a random copolymer. The various polyether intermediates generally have a number average molecular weight (Mn) as determined by assay of the terminal functional groups which is an average molecular weight greater than about 700, such as from about 700 to about 10,000, from about 1,000 to about 5,000, or from about 1,000 to about 2,500. In some embodiments, the polyether intermediate includes a blend of two or more different molecular weight polyethers, such as a blend of 2,000 Mn and 1,000 Mn PTMEG.

In one embodiment, the polyol component may include comprise a polysiloxane polyol. Suitable polysiloxane polyols include α-ω-hydroxyl or amine or carboxylic acid or thiol or epoxy terminated polysiloxanes. Examples include poly(dimethysiloxane) terminated with a hydroxyl or amine or carboxylic acid or thiol or epoxy group. In some embodiments, the polysiloxane polyols are hydroxyl terminated polysiloxanes. In some embodiments, the polysiloxane polyols have a number-average molecular weight in the range from 300 to 5,000, or from 400 to 3,000.

Polysiloxane polyols may be obtained by the dehydrogenation reaction between a polysiloxane hydride and an aliphatic polyhydric alcohol or polyoxyalkylene alcohol to introduce the alcoholic hydroxy groups onto the polysiloxane backbone.

In some embodiments, the polysiloxanes may be represented by one or more compounds having the following formula:

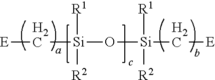

in which: each R1 and R2 are independently a 1 to 4 carbon atom alkyl group, a benzyl, or a phenyl group; each E is OH or NHR³ where R³ is hydrogen, a 1 to 6 carbon atoms alkyl group, or a 5 to 8 carbon atoms cyclo-alkyl group; a and b are each inde-pendently an integer from 2 to 8; c is an integer from 3 to 50. In amino-containing pol-ysiloxanes, at least one of the E groups is NHR³. In the hydroxyl-containing polysilox-anes, at least one of the E groups is OH. In some embodiments, both R¹ and R² are methyl groups.

Suitable examples include α,ω-hydroxypropyl terminated poly(dimethysiloxane) and α,ω-amino propyl terminated poly(dimethysiloxane), both of which are commercially available materials. Further examples include copolymers of the poly(dimethysiloxane) materials with a poly(alkylene oxide).

The polyol component, when present, may include poly(ethylene glycol), poly(tetramethylene ether glycol), poly(trimethylene oxide), ethylene oxide capped poly(propylene glycol), poly(butylene adipate), poly(ethylene adipate), poly(hexamethylene adipate), poly(tetramethylene-co-hexamethylene adipate), poly(3-methyl-1,5-pentamethylene adipate), polycaprolactone diol, poly(hexamethylene carbonate) glycol, poly(pentamethylene carbonate) glycol, poly(trimethylene carbonate) glycol, dimer fatty acid based polyester polyols, vegetable oil based polyols, or any combination thereof.

Examples of dimer fatty acids that may be used to prepare suitable polyester polyols include Priplast™ polyester glycols/polyols commercially available from Croda and Radia® polyester glycols commercially available from Oleon.

In one embodiment of the invention, the reaction mixture to form the TPU composition used herein includes about 70% by weight to about 85% by weight of the polyol component, for example, about 80% by weight to about 85% by weight.

### The Chain Extender Component

The TPU compositions described herein are made using a chain extender component. Suitable chain extenders include diols, diamines, and combination thereof.

Suitable chain extenders include relatively small polyhydroxy compounds, for example lower aliphatic or short chain glycols having from 2 to 20, or 2 to 12, or 2 to 10 carbon atoms. Suitable examples include ethylene glycol, diethylene glycol, propylene glycol, dipropylene glycol, 1,4-butanediol (BDO), 1,6-hexanediol (HDO), 1,3-butanediol, 1,5-pentanediol, neopentylglycol, 1,4-cyclohexanedimethanol (CHDM), 2,2-bis[4-(2-hydroxyethoxy) phenyl]propane (HEPP), 1,4-bis(3-hydroxyethoxy)benzene (HQEE), hexamethylenediol, heptanediol, nonanediol, dodecanediol, 3-methyl-1,5-pentanediol, ethylenediamine, butanediamine, hexamethylenediamine, and hydroxyethyl resorcinol (HER), and the like, as well as mixtures thereof. In one embodiment, the chain extender comprises or consists of 1,4-bis(3-hydroxyethoxy)benzene (HQEE). In another embodiment, the chain extender comprises or consists of 1,3-propanediol.

### The Isocyanate Component

The TPU of the present invention is made using isocyanate component. The isocyanate component may comprise one or more polyisocyanates, or more particularly, one or more diisocyanates. Suitable polyisocyanates include aromatic diisocyanates, aliphatic diisocyanates, or combinations thereof. In some embodiments, the polyisocyanate component includes one or more aromatic diisocyanates. In some embodiments, the polyisocyanate component is essentially free of, or even completely free of, aliphatic diisocyanates. In other embodiments, the polyisocyanate component includes one or more aliphatic diisocyanates. In some embodiments, the polyisocyanate component is essentially free of, or even completely free of, aromatic diisocyanates. In some embodiments, mixtures of aliphatic and aromatic diisocyanates may be useful.

Examples of useful polyisocyanates include aromatic diisocyanates such as 4,4′-methylenebis(phenyl isocyanate) (MDI), 3,3′-dimethyl-4,4′-biphenylene diisocyanate (TODI), 1,5-naphthalene diisocyanate (NDI), m-xylene diisocyanate (XDI), phe-nylene-1,4-diisocyanate, naphthalene-1,5-diisocyanate, and toluene diisocyanate (TDI); as well as aliphatic diisocyanates such as 1,6-hexamethylene diisocyanate (HDI), isophorone diisocyanate (IPDI), 1,4-cyclohexyl diisocyanate (CHDI), decane-1,10-diisocyanate, lysine diisocyanate (LDI), 1,4-butane diisocyanate (BDI), isophorone diisocyanate (PDI), and dicyclohexylmethane-4,4′-diisocyanate (H12MDI). Isomers of these diisocyanates may also be useful. Mixtures of two or more polyisocyanates may be used. In some embodiments, the isocyanate component comprises or consists of an aromatic diisocyanate. In some embodiments, the isocyanate component comprises or consists of MDI.

The combined weight percent of the diisocyanate component and the chain extender component in the TPU composition is referred to as the “hard segment content.” In one embodiment of the invention, the TPU composition useful in the present invention comprises 15% to 50% by weight or even 20% to 35% by weight hard segment.

Optionally, one or more polymerization catalysts may be present during the polymerization reaction of the TPU. Generally, any conventional catalyst can be utilized to react the diisocyanate with the polyol intermediates or the chain extender. Examples of suitable catalysts which in particular accelerate the reaction between the NCO groups of the diisocyanates and the hydroxy groups of the polyols and chain extenders are the conventional tertiary amines known from the prior art, e.g. triethylamine, dimethylcy-clohexylamine, N-methylmorpholine, N,N′-dimethylpiperazine, 2-(dimethylaminoeth-oxy)ethanol, diazabicyclo[2.2.2]octane and the like, and also in particular organometal-lic compounds, such as titanic esters, iron compounds, e.g. ferric acetylacetonate, tin compounds, e.g. stannous diacetate, stannous octoate, stannous dilaurate, bismuth compounds, e.g. bismuth trineodecanoate, or the dialkyltin salts of aliphatic carboxylic acids, e.g. dibutyltin diacetate, dibutyltin dilaurate, or the like. The amounts usually used of the catalysts are from 0.001 to 0.1 part by weight per 100 parts by weight of polyol component. In some embodiments, the reaction to form the TPU of the present invention is substantially free of or completely free of catalyst.

Reactive TPU compositions used in the present invention may be made via a “one shot” process wherein all the components are added together simultaneously or substantially simultaneously to a heated extruder and reacted to form the TPU. The equivalent ratio of the diisocyanate to the total equivalents of hydroxyl terminated intermediate and the chain extender is generally from about 0.95 to about 1.10, for example about 0.97 to about 1.03, or even about 0.98 to about 1.0. In one embodiment, the equivalent ratio may be less than 1.0 such that the TPU has terminal hydroxyl groups to enhance the reaction with the crosslinking agent during the fiber spinning process. The weight average molecular weight (MW) of the TPU is generally from about 25,000 to about 300,000, for example from about 50,000 to about 200,000, even further for example about 75,000 to about 150,000.

In another embodiment, the TPU may be prepared using a pre-polymer process. In the pre-polymer process, the hydroxyl terminated intermediate is reacted with generally an equivalent excess of one or more diisocyanates to form a pre-polymer solution having free or unreacted isocyanate therein. Subsequently, a chain extender, as described herein, is added in an equivalent amount generally equal to the isocyanate end groups as well as to any free or unreacted diisocyanate compounds. The overall equivalent ratio of the total diisocyanate to the total equivalent of hydroxyl terminated intermediate and chain extender is thus from about 0.95 to about 1.10, for example about 0.97 to about 1.03, or even about 0.98 to about 1.0. In one embodiment, the equivalent ratio may be less than 1.0 such that the TPU has terminal hydroxyl groups to enhance the reaction with the crosslinking agent during the fiber spinning process. Typically, the prepolymer process can be carried out in any conventional device, such as an extruder.

Optional additive components may be present during the polymerization reaction, and/or incorporated into the TPU elastomer described above to improve processing and other properties. These additives include but are not limited to antioxidants, organic phosphites, phosphines and phosphonites, hindered amines, organic amines, organo sulfur compounds, lactones and hydroxylamine compounds, biocides, fungicides, antimicrobial agents, compatibilizers, electro-dissipative or anti-static additives, fillers and reinforcing agents, such as titanium dixide, alumina, clay and carbon black, flame retardants, such as phosphates, halogenated materials, and metal salts of alkyl benzene-sulfonates, impact modifiers, such as methacrylate-butadiene-styrene (“MBS”) and methylmethacrylate butylacrylate (“MBA”), mold release agents such as waxes, fats and oils, pigments and colorants, plasticizers, polymers, rheology modifiers such as mono-amines, polyamide waxes, silicones, and polysiloxanes, slip additives, such as paraffinic waxes, hydrocarbon polyolefins and/or fluorinated polyolefins, and UV stabilizers, which may be of the hindered amine light stabilizers (HALS) and/or UV light absorber (UVA) types. Other additives may be used to enhance the performance of the TPU com-postion or blended product. All of the additives described above may be used in an ef-fective amount customary for these substances.

These additional additives can be incorporated into the components of, or into the reaction mixture for, the preparation of the TPU resin, or after making the TPU resin. In another process, all the materials can be mixed with the TPU resin and then melted or they can be incorporated directly into the melt of the TPU resin.

### The Isocyanate Functional Prepolymer Crosslinking Agent

The reactive TPU composition described above is combined with an isocyanate functional prepolymer crosslinking agent to make the melt-spun fiber of the present invention. The prepolymer crosslinking agent is the reaction product of a hydroxyl terminated polyol comprising or consisting of a second polycarbonate polyol or a polycaprolactone polyol with an excess of diisocyanate. The polycarbonate polyol or polycaprolactone polyol useful in forming the isocyanate functional prepolymer cross-linking agent may be selected from those described herein with respect to the TPU composition. For example, the polycaprolactone polyol F-caprolactone may be reacted with bifunctional initiator such as diethylene glycol, 1,4-butanediol, neopentyl glycol, PTMEG or any of the other glycols and/or diols known in the art. The diisocyanate useful for preparation of the isocyanate functional prepolymer crosslinking agent may also be selected from those described herein with respect to the TPU composition. The prepolymer cross-linking agent has an isocyanate functionality greater than 1.0, for example, from about 1.5 to 2.5, further for example about 1.8 to 2.2. The isocyanate functional pre-polymer crosslinking agent may be prepared using the prepolymer process as described herein where a hydroxyl terminated intermediate is reacted with an equivalent excess of one or more diisocyanates to form a pre-polymer solution having free or unreacted isocyanate.

### Thermoplastic Polyurethane Fibers

The thermoplastic polyurethane fibers of the present invention comprise about 80% by weight to about 95% by weight, or even about 85% by weight to 90% by weight, of the reactive TPU described herein and about 5% by weight to about 20% by weight, or even about 10% by weight to about 15% by weight of the isocyanate functional prepolymer crosslinking agent. The percentage of crosslinking agent used is a weight percent based on the total weight of TPU and crosslinking agent.

Melt-spun TPU fibers are made by melting the TPU composition in an extruder and adding the crosslinking agent to the melted TPU. The TPU melt with the crosslinking agent is fed to a spinneret. The melt exits the spinneret to form the fibers and the fibers are cooled and wound onto bobbins. The process includes the following steps: (1) preparing a reactive thermoplastic polyurethane composition that is the reaction product of (a) a polyol component, wherein the polyol component comprises or consists of a first polycarbonate polyol, (b) a chain extender component; and (c) a diisocyanate; (2) drying the reactive thermoplastic polyurethane composition; (3) melting the reactive thermoplastic polyurethane composition in an extruder; (4) adding an isocyanate functional prepolymer into the extruder; (5) mixing the reactive thermoplastic polyurethane composition and the isocyanate functional prepolymer in the extruder to form a crosslinked thermoplastic polyurethane polymer; (6) feeding the crosslinked thermoplastic polyurethane polymer to at least one spinneret to produce a melt-spun fiber; (7) cooling the melt-spun fiber; (8) optionally, applying finish oil; and (9) winding the melt-spun fiber onto a bobbin core. The steps of this process will be described in more detail below.

The melt-spinning process begins with feeding a preformed reactive TPU polymer, into an extruder. The reactive TPU is melted in the extruder and the cross-linking agent is added continuously downstream near the point where the TPU melt exits the extruder or after the TPU melt exits the extruder. If the crosslinking agent is added after the melt exits the extruder, the crosslinking agent needs to be mixed with the TPU melt using static or dynamic mixers to assure proper combining of the crosslinking agent into the TPU polymer melt. After exiting the extruder and mixer, the melted TPU polymer with crosslinking agent flows into a manifold. The manifold divides the melt stream into different streams, where each stream is fed to a plurality of spinnerets. Usually, there is a melt pump for each different stream flowing from the manifold, with each melt pump feeding several spinnerets. The spinneret will have a small hole through which the melt is forced and exits the spinneret in the form of a fiber. The size of the hole in the spinneret will depend on the desired size (denier) of the fiber. The fiber is drawn or stretched as it leaves the spinneret and is cooled before winding onto bobbins. The fibers are stretched by winding the bobbins at a higher speed than that of the fiber exiting the spinneret. For the melt-spun TPU fibers, the bobbins are usually wound at a rate that is greater than the speed of the fiber existing the spinneret, for example, in some embodiments, of 4 to 8 times the speed of the fiber exiting the spinneret, but can be wound slower or faster depending on the particular equipment. Typical bobbin winding speeds can vary from 100 to 3000 meters per minute, but more typical speeds are 300 to 1200 meters per minute for TPU melt-spun fibers. Finish oils, such as silicone oils, are usually added to the surface of the fibers after cooling and just prior to being wound into bobbins.

An important aspect of the melt spinning process is the mixing of the TPU polymer melt with the crosslinking agent. Proper uniform mixing is important to achieve uniform fiber properties and to achieve long run times without experiencing fiber break-age. The mixing of the TPU melt and crosslinking agent should be a method which achieves plug-flow, i.e., first in first out. The proper mixing can be achieved with a dynamic mixer or a static mixer. For example, a dynamic mixer which has a feed screw and mixing pins may be used. U.S. Pat. No. 6,709,147 describes such a mixer and has mixing pins which can rotate.

The TPU is reacted with the prepolymer crosslinking agent during the fiber spinning process to give a weight average molecular weight (MW) of the TPU in fiber form of from about 50,000 Daltons to about 400,000 Daltons, preferably from about 100,000 Daltons to about 300,000 Daltons. The reaction in the fiber spinning process between the TPU and the prepolymer crosslinking agent at the point where the TPU exits the spinneret should be above 20%, preferably from about 30% to about 60%, and more preferably from about 40% to about 50%. Typical prior art TPU melt spinning reaction between the TPU polymer and the crosslinking agent is less than 20% and usually about 10-15% reaction. The reaction is determined by the disappearance of the NCO groups. The higher % reaction of this invention improves melt strength thus allowing a higher spinning temperature which improves the spinnability of the TPU. The fibers are nor-mally aged in an oven on the bobbins until the molecular weight plateaus.

Melt-spun TPU fibers can be made in a variety of denier. The term “denier” is defined as the mass in grams of 9000 meters of fiber, filament, or yarn. It is describing linear density, mass per unit length of fibers, filaments, or yarns and is measured according to ASTM D1577, Option B. Typical melt-spun TPU fibers are made in a denier size less than 1080, for example, from 10 to 240 denier, or even 20, 40, 70 and 140 denier.

The melt-spun fibers made in accordance with the present invention have unique physical properties not exhibited by prior art TPU fibers. In some embodiments, the fibers of the present invention exhibit unique elasticity properties and resistance to chemicals.

### Fabrics

The TPU fibers of the present invention are combined with natural or syn-thetic other fibers by knitting or weaving fibers to make fabrics which can be used in a variety of articles. It is desirable to dye such fabrics in various colors.

The melt-spun TPU fibers of this invention may be combined with other fibers, such as different TPU fibers, cotton, nylon or polyester to make various end use articles, including clothing garments.

For example, a fabric in accordance with the present invention may combine the melt-spun TPU fiber of the present invention with a different TPU fiber or a yarn that is not made from TPU and is less elastic than the TPU fibers of the present invention, also referred to herein as a “hard yarn.” Hard yarns may include, for example, different TPU fibers, polyester, nylon, cotton, wool, acrylic, polypropylene, or viscose-rayon. In one embodiment, the hard yarn has ultimate elongation of 10%-200%, for example, 10% to 75%, or even 10% to 50%, or even 10% to 30% and the melt-spun TPU fiber of the present invention has at least 300% ultimate elongation, for example 300% to 650% ultimate elongation. Each of the fiber components may be included in amounts of 1-99% by weight in the composition. The weight % of the melt-spun TPU fibers in the end use application can vary depending on the desired elasticity. For example, woven fabrics have from 1-8 wt. %, underwear from 2-5 wt. % bathing suits and sportswear from 8-30 wt. % foundation garments from 10-45 wt. %, and medical hose from 35-60 wt. % of the melt-spun TPU fibers with the remaining amount being a hard, non-elastic fiber. The fabrics made with these two fiber materials can be constructed by various processes including but not limited to circular knitting, warp knitting, weaving, braiding, nonwovens or combination thereof. In one embodiment, fabrics made of the fibers of the present invention may have a stretch of more than 50% or even more than 100% measured by ASTM D4964.

In this application and in the following examples, the following properties are referred to along with the methods for measuring such properties:
Tensile strength of prepared films was measured per ASTM D412
Tensile set of prepared films was measured per ASTM D412
Denier is the measure of linear density and is measured as per ASTM D1577, Option B;
The tenacity of elastic filaments which is tensile strength normalized by denier was also measured and reported per ASTM D2653;
The ultimate elongation of elastic filaments which is elongation at break was also measured and reported per ASTM D2653;
Hysteresis as defined and calculated as mentioned previously herein at re-spective elongations and reported per ASTM D2731 for elastic filaments;
For hard yarns like polyester which are in-elastic, tenacity and elongation were measured and ASTM D2256 standard was used;
Oleic acid chemical resistance of comparative and inventive examples was measured and reported per ASTM D543-20

The invention will be better understood by reference to the following examples.

### EXAMPLES

| | | | Chain | |
|---|---|---|---|---|
| Example | Polyol | Mn | Extender | Diisocyanate |
| A | HDO/BDO Adipate | 2500 | BDO | MDI |
| B | PTMEG | 1000 | HQEE | MDI |
| C | PTMEG/Caprolactone | 1550 | BDO | MDI |
| D | Polycarbonate | 2000 | BDO | MDI |
| | (6 carbon) | | | |
| E | PTMEG/Polycarbonate | 1800/2000 | BDO | MDI |
| | (6 carbon) | | | |
| F | Polycarbonate | 2000 | HQEE | MDI |
| | (6 carbons) | | | |
| G | Polycarbonate | 2000 | HQEE | MDI |
| H | Polycarbonate | 2000 | HQEE | MDI |
| I | Polycarbonate | 1000 | HQEE | MDI |
| | (6 carbon) | | | |
| J | Polycarbonate | 2000 | HQEE | MDI |
| | (6 carbon) | | | |
| K | Polycarbonate | 3000 | HQEE | MDI |
| | (6 carbon branched) | | | |
| L | Mixture of Polyol | 2000/3000 | HQEE | MDI |
| | Mn = 2000, 70% and | | | |
| | Polyol Mn = 3000, | | | |
| M | 30% Mixture of Polyol | 2000/3000 | HQEE | MDI |
| | Mn = 2000, 50% and | | | |
| | Polyol Mn = 3000, | | | |
| N | 50% Polycarbonate | 2000 | HQEE | MDI |
| | (4 carbon) | | | |
| O | Polycarbonate | 2000 | HQEE | MDI |
| | (4 carbon) | | | |
| P | Polycarbonate | 2000 | PDO | MDI |
| | (6 carbon) | | | |
| Q | Polycarbonate | 2000 | PDO | MDI |
| | (6 carbon) | | | |
| R | Polycarbonate | 2000 | PDO | MDI |
| | (6 carbon) | | | |

On exiting the extruder TPU candidates from Table 1 were subjected to chemical (oleic acid) exposure per ASTM D543-20 and examples with lowest decrease in tensile strength were selected for fiber spinning. Table 2 compares the oleic acid resistance for examples prepared from Table 1.

TABLE 2

| | Control | | Chemical Resistance | | | | |
|---|---|---|---|---|---|---|---|
| | Stress | Strain | Stress | Strain | | | Tensile |
| | psi | % | psi | % | % Change in | | Set |
| Example | Mean | Mean | Mean | Mean | Stress | Strain | % |
| A | 7058 | 827 | 195 | 116 | −97.2 | −85.9 | 0 |
| B | | | Gels¹ | | | | |
| C | | | Gels¹ | | | | |
| D | 8754 | 359 | 4524 | 214 | −48.3 | −40.5 | 12.1 |
| E² | | | | | | | |
| F | 5088 | 474 | 3490 | 603 | −31.4 | 27.2 | 0.4 |
| G | 4534 | 429 | 4513 | 621 | −0.5 | 44.8 | 0.4 |
| H | 4502 | 359 | 4524 | 497 | 0.5 | 38.2 | 2.4 |
| I | 4504 | 437 | 3161 | 646 | −29.8 | 48.0 | 2.4 |
| J | 4502 | 359 | 4524 | 497 | 0.5 | 38.2 | 2.4 |
| K | 3152 | 530 | 3249 | 768 | 3.1 | 44.9 | 1.4 |
| L | 4294 | 398 | 4646 | 575 | 8.2 | 44.3 | 0.4 |
| M | 3631 | 477 | 3945 | 593 | 8.7 | 24.3 | 0.4 |
| N | 4965 | 367 | 5685 | 516 | 14 | 41 | 6.3 |
| O | 4452 | 467 | 4964 | 639 | 11 | 37 | 7.4 |
| P | 4795 | 383 | 5516 | 704 | 15 | 84 | 0.4 |
| Q | 6991 | 519 | 4535 | 889 | −35 | 71 | 0.4 |
| R | 4828 | 411 | 3707 | 919 | −23 | 123 | 0.4 |

¹Gels = Examples labelled as “Gels” turned into complete gel unsuitable for testing any physical properties, implying very poor resistance to oleic acid due to plasticization.
²Not tested

Examples G, H, L, and R were chosen for fiber spinning due to highest resistance to oleic acid and lowest loss in tensile set from Table 2. Examples M through T also provided chemical resistance, however for ease of processing during fiber spinning, examples G and H were selected.

For fiber spinning, 10% weight of prepolymer crosslinking agent correspond-ingly listed in Table 3 was mixed with the TPU polymer melt in a dynamic mixer (90 wt % TPU polymer melt/10 wt % crosslinker) and then pumped through a manifold to spinnerets. The polymer stream emanating the spinneret was cooled by air, a silicon finish oil applied, and the fiber formed was wound into a bobbin. The fiber on the bobbins were heat aged at 80° C. for 24 hours before testing the physical properties of the fibers. Table 3 summarizes the TPU and cross-linker combinations used to make fibers.

TABLE 3

| Fiber | TPU | |
|---|---|---|
| Examples | Examples | Cross-linker Type |
| 1 | A | PTMEG + MDI prepolymer, |
| | | available isocyanate 6.6% |
| 2 | B | PTMEG + MDI prepolymer, |
| | | available isocyanate 6.6% |
| 3 | C | PTMEG + MDI prepolymer, |
| | | available isocyanate 6.6% |
| 4 | H | NONE |
| 5 | H | NPG Adipate + MDI prepolymer, |
| | | available isocyanate 6.6% |
| 6 | H | Polycaprolactone MDI prepolymer, |
| | | available isocyanate 6.8% |
| 7 | H | Polycarbonate MDI prepolymer, |
| | | available isocyanate 10% |
| 8 | H | Polycarbonate MDI prepolymer, |
| | | available isocyanate 6.6% |
| 9 | G | NONE |
| 10 | G | NPG Adipate + MDI prepolymer, |
| | | available isocyanate 6.6% |
| 11 | G | Polycaprolactone MDI prepolymer, |
| | | available isocyanate 6.8% |
| 12 | G | Polycarbonate MDI prepolymer, |
| | | available isocyanate 10% |
| 13 | G | Polycarbonate MDI prepolymer, |
| | | available isocyanate 6.6% |
| 14 | R | NONE |
| 15 | R | NPG Adipate + MDI Prepolymer, |
| | | available isocyanate 6.6% |

The data in Tables 4 and 5 illustrate that fiber examples prepared with polycarbonate based TPU and polycarbonate based prepolymer crosslinker and polycarbonate based TPU and polycaprolactone based prepolymer crosslinker unexpectedly show the best performance after chemical exposure.

TABLE 4

| | | | Values after oleic acid | | | |
|---|---|---|---|---|---|---|
| | Control | | exposure | | | |
| | Tenacity | Break | Tenacity | Break | | |
| Fiber | gram-force/ | Elongation | gram-force/ | Elongation | % Change in | |
| Examples | Denier | % | Denier | % | Load | Elongation |
| 1 | 1.4 | 555 | 0.3 | 573 | −79 | 3 |
| 2 | Completely plasticized in oleic acid | | | | | |
| 3 | Completely plasticized in oleic acid | | | | | |
| 4 | 1.3 | 392 | 1.2 | 460 | −8 | 17 |
| 5 | 1.1 | 368 | 0.9 | 418 | −19 | 14 |
| 6 | 1.0 | 424 | 0.8 | 586 | −23 | 38 |
| 7 | 1.2 | 449 | 0.9 | 516 | −26 | 15 |
| 8 | 1.0 | 407 | 0.7 | 595 | −24 | 46 |
| 9 | 1.5 | 290 | 1.3 | 446 | −14 | 54 |
| 10 | 1.2 | 314 | 0.9 | 399 | −22 | 27 |
| 11 | 1.0 | 337 | 0.8 | 554 | −19 | 64 |
| 12 | 0.9 | 267 | 0.8 | 405 | −7 | 52 |
| 13 | 0.9 | 396 | 0.8 | 510 | −7 | 29 |
| 14 | 1.2 | 366 | 1.1 | 514 | −7 | 40 |
| 15 | 1.2 | 378 | 0.8 | 488 | −35 | 29 |

TABLE 5

| | Set - Control (%) | | Set after chemical Exposure (%) | | Hysteresis after 5th cycle | |
|---|---|---|---|---|---|---|
| Fiber | Load | Unload | Load | Unload | | Oleic Acid |
| Ex. | Cycle | Cycle | Cycle | Cycle | Control | Exposed |
| 4 | 50 | 83 | 45 | 52 | 33 | 8 |
| 5 | 40 | 58 | 46 | 68 | 18 | 23 |
| 6 | 32 | 41 | 37 | 48 | 9 | 11 |
| 7 | 31 | 39 | 32 | 41 | 8 | 10 |
| 8 | 27 | 37 | 33 | 44 | 10 | 11 |
| 9 | sample | sample | 43 | 56 | sample | 13 |
| | failed | failed | | | failed | |
| 10 | 41 | 58 | 40 | 58 | 17 | 18 |
| 11 | 24 | 31 | 29 | 37 | 7 | 8 |
| 12 | 28 | 42 | 33 | 45 | 14 | 13 |
| 13 | 25 | 33 | 28 | 35 | 8 | 8 |
| 14 | 34 | 51 | 37 | 48 | 16 | 11 |
| 15 | 28 | 42 | 44 | 60 | 14 | 16 |

Each of the documents referred to above is incorporated herein by reference including any prior applications, whether or not specifically listed above, from which priority is claimed. The mention of any document is not an admission that such document qualifies as prior art or constitutes general knowledge of the skilled person in any juris-diction. Except in the Examples, or whether otherwise explicitly indicated, all numerical quantities in this description specifying amounts of materials, reaction conditions, molecular weights, number of carbon atoms, and the like are to be understood as modified by the word “about.” It is to be understood that the upper and lower amount, range, and ratio limits set forth herein may be independently combined. Similarly, the ranges and amounts for each element of the invention can be used together with ranges or amounts for any of the other elements.

As used herein, the transitional term “comprising,” which is synonymous with “including,” “containing,” or “characterized by,” is inclusive or open-ended and does not exclude additional, un-recited elements or method steps. However, in each recitation of “comprising” herein, it is intended that the term also encompass, as alternative embodiments, the phrases “consisting essentially of” and “consisting of,” where “consisting of” excludes any element or step not specified and “consisting essentially of” permits the inclusion of additional un-recited elements or steps that do not materially affect the basic and novel characteristics of the composition or method under consideration.

While certain representative embodiments and details have been shown for the purpose of illustrating the subject invention, it will be apparent to those skilled in this art that various changes and modifications can be made therein without departing from the scope of the subject invention. In this regard, the scope of the invention is to be limited only by the following claims.

1. A melt-spun fiber, comprising:
(a) a reactive thermoplastic polyurethane composition, comprising the reaction product of:
i. a polyol component, wherein the polyol component comprises a first polycarbonate polyol;
ii. a hydroxyl terminated chain extender component; and
iii. a first diisocyanate component; and
(b) an isocyanate functional prepolymer crosslinking agent comprising the reaction product of a second polycarbonate polyol and a second diisocyanate component, or
(c) an isocyanate functional prepolymer crosslinking agent comprising the reaction product of a polycaprolactone polyol and a second diisocyanate component

2. The melt-spun fiber of claim 1, wherein the polyol component comprises at least 60% of the first polycarbonate polyol.

3. The melt-spun fiber of claim 1, wherein the first polycarbonate polyol contains a repeating unit —R—O—C(═O)—O— in which R contains 4 to 6 carbon atoms.

4. The melt-spun fiber of claim 1, wherein the first polycarbonate polyol has a number average molecular weight of about 1000 to 3000 Daltons measured by end group analysis, optionally wherein the first polycarbonate polyol is selected from 2-MPD carbonate, BDO-carbonate, DEG-carbonate, HDO-carbonate, or mixtures thereof.

5. The melt-spun fiber of claim 1, wherein the polyol component consists of the first polycarbonate polyol.

6. The melt-spun fiber of claim 1, wherein the chain extender component comprises 1,4-bis(p-hydroxyethoxy)benzene or 1,3 propanediol.

7. The melt-spun fiber of claim 1, wherein the first diisocyanate component comprises an aromatic diisocyanate, 4,4′-diphenylmethane diisocyanate, an aliphatic diisocyanate, HDI, or mixtures thereof.

8. The melt-spun fiber of any preceding claim 1, wherein the second diisocyanate component comprises an aromatic diisocyanate, 4,4′-diphenylmethane diisocyanate, an aliphatic diisocyanate, HDI, or mixtures thereof.

9. The melt-spun fiber of claim 1, wherein the second polycarbonate polyol is selected from HDO-carbonate, BDO-carbonate, 3-MPD-carbonate, or mixtures thereof.

10. The melt-spun fiber of claim 1, wherein the polycaprolactone polyol comprises F-caprolactone and may be reacted with bifunctional initiator, optionally wherein the bifunctional initiator is selected form diethylene glycol, 1,4-butanediol, neopentyl glycol, poly(tetramethylene ether glycol) or mixtures thereof.

11. The melt-spun fiber of claim 1, wherein the reactive thermoplastic polyurethane composition contains 70% to 85% by weight of the first polycarbonate polyol component.

12. The melt-spun fiber of claim 1, wherein a combined weight of the hydroxyl terminated chain extender component and the first diisocyanate component make up a hard segment of the thermoplastic polyurethane composition and wherein the thermoplastic polyurethane composition has a hard segment content of 15% to 45% by weight.

13. The melt-spun fiber of claim 1, wherein the isocyanate functional prepolymer crosslinking agent comprises the reaction product of 65% to 80% by weight of the second polycarbonate polyol and 20% to 35% by weight of the second diisocyanate component.

14. The melt-spun fiber of claim 1, comprising 85% to 90% of the TPU and 10% to 15% of the pre-polymer.

15. The melt-spun fiber of claim 1, wherein the melt-spun thermoplastic polyurethane fiber has a weight average molecular weight measured by gas permeation chromatography of 100,000 Daltons to 300,000 Daltons.

16. The melt-spun fiber of claim 1, wherein the thermoplastic polyurethane fiber is capable of retaining at least 80% of its original tensile properties measured according to ASTM D2653 after exposure to oleic acid measured per ASTM D543-20.

17. A fabric comprising the melt-spun fiber of claim 1.

18. A process for preparing the melt-spun fiber of claim 1, the process comprising the steps of:
(1) preparing a reactive thermoplastic polyurethane composition that is the reaction product of (a) a polyol component, wherein the polyol component comprises a first polycarbonate polyol (b) a chain extender component; and (c) a first diisocyanate;
(2) drying the reactive thermoplastic polyurethane composition;
(3) melting the reactive thermoplastic polyurethane composition in an extruder;
(4) adding an isocyanate functional prepolymer into the extruder, wherein the isocyanate functional prepolymer comprises the reaction product of a second polycarbonate polyol or a polycaprolactone polyol and a second diisocyanate component;
(5) mixing the reactive thermoplastic polyurethane composition and the isocyanate functional prepolymer in the extruder to form a crosslinked thermoplastic polyurethane polymer;
(6) feeding the crosslinked thermoplastic polyurethane polymer to at least one spinneret to produce a melt-spun fiber;
(7) cooling the melt-spun fiber;
(8) optionally, applying finish oil; and
(9) winding the melt-spun fiber onto a bobbin.
